(19) United States
(12) Patent Application Publication
(10) Pub. No.: US 2008/0302178 A1
(43) Pub. Date: Dec. 11, 2008

(54) Method and system for dispensing precise reagent volumes

(76) Inventor: Jeffrey Karg, Hopkington, MA (US)

Correspondence Address: Paul J. Cook, 115 Pine St., Manchester, MA, 01944, US

(21) Appl. No.: 12/157,357

(22) Filed: Jun. 10, 2008

Related U.S. Application Data
(60) Provisional application No. 60/934,040, filed on Jun. 11, 2007.

(51) Int. Cl. G01F 15/00; G01F 13/00

(52) U.S. Cl. 73/199; 73/861.41

(57) ABSTRACT

A method and system for dispensing small volumes of liquid reagents is provided. The system includes a sequence of one, two, or three or more sensors, attached to a conduit, which send an electronic signal indicating the presence or lack of fluid in the conduit. The sensors can sense the leading edge of a fluid in a conduit, often called the leading meniscus. The sensors are connected to a microprocessor capable of recording the time the leading meniscus passes each sensor. The microprocessor can also calculate the time difference between the sensors, and at a constant flow rate, determine the speed of the fluid in the conduit and proportionally, depending on the diameter of the conduit, calculate the flow rate within the conduit. The microprocessor can also control the pump to cause the fluid to flow for a specific period of time so that a known discrete volume can be dispensed from the conduit. The microprocessor can also control a pump allowing the leading meniscus to be positioned accurately within the conduit.

### REFERENCE TO RELATED APPLICATION

This application is based on provisional application Ser. No. 60/934,040, filed Jun. 11, 2007.

### FIELD OF THE INVENTION

This invention relates to a method and system for dispensing discrete sub microliter, microliter or milliliter liquid reagents.

### BACKGROUND OF THE INVENTION

The science and economics of invitro diagnostic (IVD) testing has changed with developments in assay reagent variation and assay size miniaturization. The number of assays performed annually is increasing as population demographics change and the availability of diagnostic testing increases throughout the world. Instrumentation is constantly adapted to these changing conditions. The reagents are harsher, including increased usage of salt solutions and acid and alkaline solutions having significant pH ranges. The liquid that pumps must move is decreasing from milliliters in volume to microliters to nanoliters in volume while precision and accuracy requirements remain constant. Lastly, the instrumentation is required to perform more tests prior to regular or unscheduled maintenance.

An important fluidic component to successful IVD instrumentation is precise control of non-contact dispensing of assay reagents. Many reagents are dispensed in a contact manner, in which a clean probe contacts the reagent in its reservoir and then dispenses the reagent into the assay site. The probe must be cleaned or replaced after each contact. Many reagents are also dispensed in non-contact mode, but there are limitations as to accuracy, precision and the velocity that the fluid may be dispensed into the assay site, particularly cell-based assays.

This non-contact dispensing problem is difficult because the reagents are not dispensed in consistent volumes and some reagents need to be non-contact dispensed in as little as 5 uL increments. Small volumes are more difficult to dispense than larger volumes.

Accordingly, it would be desirable to provide a method and system for delivering a plurality of precise volumes of reagents in series. In addition, it would be desirable to provide such a method and system that is capable of adjusting for anomalies in the reagent delivery apparatus. Such a method and system would provide a reliable reagent delivery system over extended times.

### SUMMARY OF THE INVENTION

The method and system of this invention is based upon the sensing of the meniscus of the leading surface of a reagent within a conduit and when present, the meniscus of the leading surface and the trailing surface of a bubble within the reagent and, when present, the leading surface of a volume of fluid and the trailing surface of a volume of fluid. The reagent is pumped from a reservoir by a pump connected to a valve that can be closed or open. The valve is positioned between the reservoir and the pump and it can be open or closed to effect aspiration or dispense of reagent. The meniscus of dispensed reagent within a conduit is sensed with a meniscus sensing apparatus that is connected with appropriate electronic circuits activated. This meniscus sensing apparatus can be located within a precise distance or volume from the exit of the dispensing nozzle enabling, in turn, precise locating of the leading edge of the liquid in the conduit. This location serves as a fluid homing switch for the leading edge meniscus providing for a precise starting point of a dispense volume. Knowing the precise starting point of a dispense enables precise and accurate dispensing of very small volumes by compensating for any system variables, such as leaks or solenoid valve pumping action, that would unexpectantly move the leading edge meniscus. Imprecise location of the leading edge meniscus will lead to inaccuracy when dispensing small volumes of liquid. In addition, if two meniscus detection devices are employed sequentially, the time measured during constant flow between the two detection devices can be used in combination with a volumetric constant to determine flow rates through the conduit. In addition, anomalies in the reagent dispensing apparatus such as a leakage allowing a compressible bubble to enter the fluid stream can be used to compensate for the volume lost in the bubble by adding dispense time onto the end of the dispense cycle.

In addition to a single meniscus detector used as a homing switch or two detectors used as a time-based flow sensor, three or more detectors can be put in series. The leading edge of the meniscus can be drawn up by the pump to be above all detectors. As the fluid column is moved at constant velocity, the first two detectors can be used to obtain an accurate flow rate, while a third detector can be used to trigger the counting of steps the stepper motor in the pump should move. Simultaneously, a timer can be triggered to record the number of seconds the pump has been moving and a stepper motor stall detection circuit can verify the stepper motor being moved continuously without stalling. The three events, counting steps, time of dispense and lack of motor stalling correlate and provide validation the desired volume has been dispensed.

Another use for this invention is the accurate and validated aspiration from one container and subsequent dispense into another container. Often reagents are aspirated from one container such as a microtitre plate or other container and dispensed into another microtitre plate or other container. The probes or nozzles, defined herein as the conduit, sometimes become clogged or there is some other malfunction preventing the fluid from aspiration into the probe or conduit. It is valuable to know if the fluid has been aspirated. In this case, the conduit, not filled with fluid, is placed into a container of fluid. The microprocessor controls the pump stepper motor to aspirate fluid. The first sensor, the sensor closest to the conduit exit, detects the passing of the leading surface of the volume of fluid and triggers a timer. As the leading surface passes the second sensor, the velocity and subsequently the flow rate are established. As above, when combined with a stall detection circuit in the microprocessor, the three events, counting steps, time of dispense, and lack of stepper motor stalling correlate and provide validation the desired volume has been aspirated. Persons skilled in the art would also understand that combinations of validated aspirations and dispenses could be combined in multiple ways to provide for validated sequences of fluid aspirations and dispenses, which are important in the constructing of assays by adding many different fluids in different amounts and at different times using the same or different probes or conduits.

In its simplest form, the above validated dispense and aspiration with the use of just one sensor, could provide information of the presence of fluid and the times of aspiration and dispense and not be used for validating the actual volume.

### BRIEF DESCRIPTION OF THE DRAWINGS

FIG. 1 is a schematic view of the fluid dispensing apparatus of this invention.

FIG. 2 is a schematic view of an alternative sensing system of this invention.

FIG. 3a is a side view of a reagent sample at its fully aspirated position.

FIG. 3b is a side view of a reagent sample in a travel position.

FIG. 3c is a side view of a reagent sample in a fully dispensed position.

FIG. 4 is a schematic view of electronic circuitry utilized in the present invention.

FIG. 5a is an alternative schematic view of the fluid aspiration apparatus of this invention.

FIG. 5b is an alternative schematic view of the fluid dispense apparatus of this invention.

FIG. 6a is a side view of an empty conduit in a container of fluid prior to aspiration.

FIG. 6b is a side view of a reagent sample travel position.

FIG. 6c is a side view of a reagent sample contained in the conduit.

FIG. 6d is a side view of a reagent sample in a fully aspirated position.

FIG. 6e is a side view of a reagent sample after dispense into a container.

### DESCRIPTION OF SPECIFIC EMBODIMENTS

The method and system of this invention is capable of sensing the presence of liquid within a specific location within a conduit and of identifying the moment a meniscus passes a specific location within the conduit. Based upon these sensing capabilities, the method and system of this invention provides the exact location of the leading meniscus at each meniscus detector and the presence or absence of a bubble within the reagent at each meniscus detector. In addition, the travel time of a meniscus between meniscus detectors and the proportional reagent flow rate of the reagent are determined so that reagent sample volume can be controlled as desired.

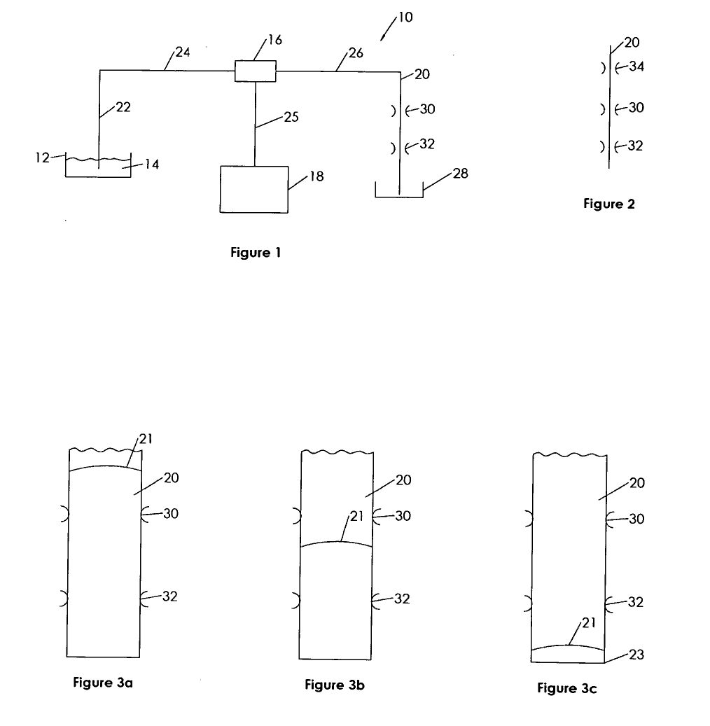

Referring to FIG. 1, the apparatus utilized to effect fluid flow in the present invention 10 comprises a reservoir 12 for liquid 14, a valve 16 and a pump 18. The valve 16 is capable of controlling fluid flow within conduits 20, 22, 24 and 25 when it is desired to aspirate reagent or to dispense reagent from conduit 26 into container 28. Meniscus detectors 30 and 32 are provided to detect the presence or absence of a meniscus within conduit 26. Representative suitable meniscus detectors include optical detectors, infrared light emitting diodes (IRLED), vertical cavity surface emitting lasers (VCSEL) or the like.

Referring to FIG. 2, three meniscus detectors 30, 32 and 34 can be utilized in the apparatus of FIG. 1. Detector 34 can be utilized to directly sense the leading meniscus at a desired home position. Persons skilled in the art can utilize the three sensors in any combination of homing position and flow rate determination.

Referring to FIGS. 3a, 3b and 3c, in use, the pump 18 is activated and the valve 16 directs liquid 14 from reservoir 12 and into conduit 20. The leading meniscus 21 is initially positioned upstream of detector 30 at a predetermined home position within conduit 20 as shown in FIG. 3a. This permits a ramp up time to attain a desired conduit flow rate within conduit 20 so that the leading meniscus 21 passes detectors 30 and 32 at the same flow rate. The time of meniscus flow between detectors 30 and 32 is determined. Since the conduit volume between detectors 30 and 32 is known, the fluid flow rate within conduit 20 and fluid volume dispensed can be determined. At the end of the dispense cycle the meniscus 21 is positioned at the open end 23 of conduit 20 as shown in FIG. 3c.

The reagent then is aspirated past detectors 30 and 32 for a predetermined time, thereby to position the leading meniscus at a predetermined desired home position. The dispense and aspiration steps are then repeated. The desired home position can be recalibrated, if desired to compensate for any anomalies in the system such as leakage.

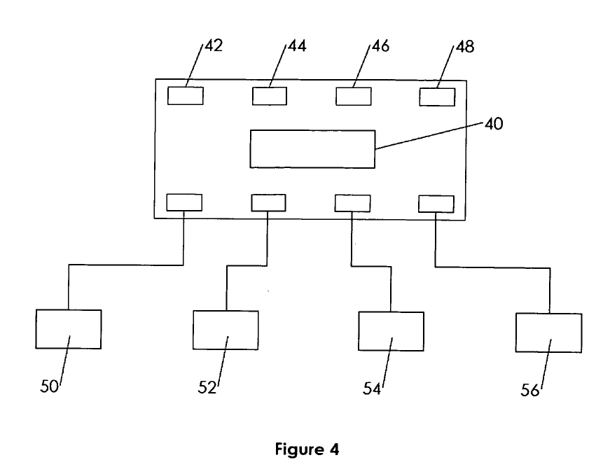

Referring to FIG. 4, the electronic circuitry suitable for effecting this invention is shown. The circuitry includes a microprocessor 40, that is connected to a computer (not shown), a power supply connection 42, a communications port 44 which functions as portal for downloading firmware to the microprocessor, an analog output 46 which functions as a port for the analog signal reporting the time the fluid takes to travel from one meniscus detector to the next detector and a digital output port 48 which functions as a portal for high/low ttl signal from each meniscus detector, where a high ttl signal can indicates the presence of fluid. Persons skilled in the art can also have the presence of fluid indicated by a low ttl signal. Daughterboards 50, 52, 54, and 56 provide the signal conditioning for the meniscus detector's optical components such as signal amplification. The daughterboards also contain a potentiometer, one for each detector, to grossly calibrate them to within range where software calibration can take over. The detectors also can be fully calibrated by software.

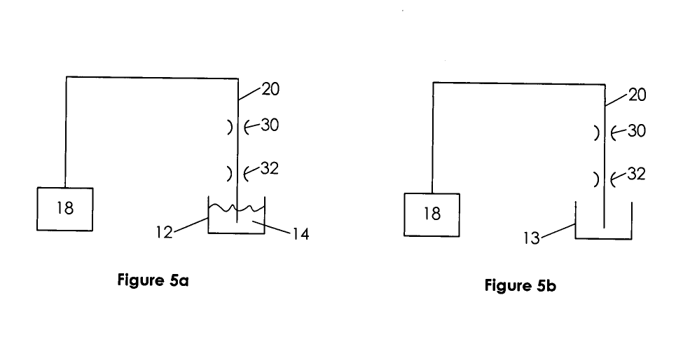

Referring to FIGS. 5a and 5b, the apparatus utilized to effect fluid flow in the present alternative invention 11 comprises a container 12 for liquid 14, a conduit 20, a pump 18 and another container 13. The pump 18 is capable of controlling fluid flow within conduit 20 when it is desired to aspirate fluid 14 from container 12 into conduit 20 and, when conduit 20 is moved to another container 13, to dispense fluid 14 from conduit 20 into container 13. Meniscus detectors 30 and 32 are provided to detect the presence or absence of a meniscus within conduit 20. Representative suitable meniscus detectors include optical detectors, infrared light emitting diodes (IRLED), vertical cavity surface emitting lasers (VCSEL) or the like.

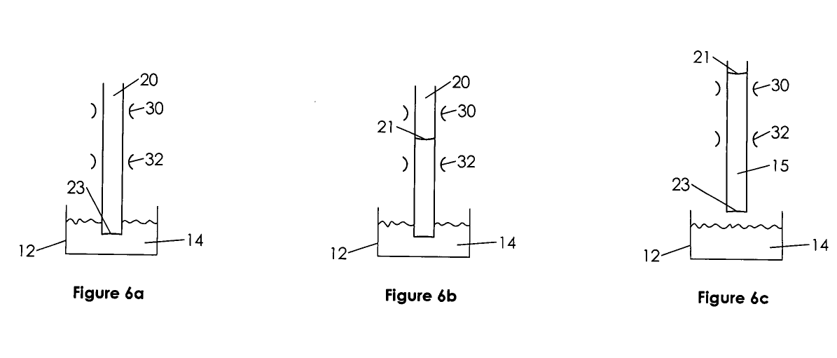

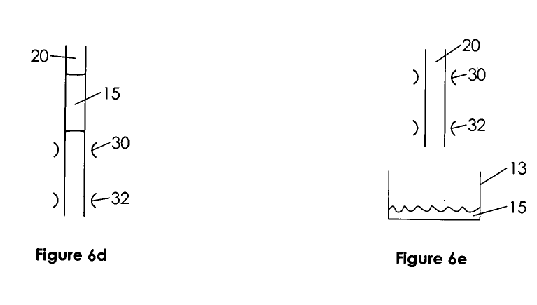

Referring to FIGS. 6a, 6b, 6c, 6d, and 6e three meniscus detectors 30, 32, and 34 can be utilized in the apparatus of FIGS. 5a and 5b to validate the aspiration of a fluid 14 into conduit 20 and subsequently the dispense of the fluid from conduit 20 into container 13. In this embodiment, the conduit 20 is not initially filled with fluid between the open end 23 and sensor 30 or may not be filled at all. The open end 23 of conduit 20 is placed into a container 12 of fluid 14. The pump 18 is capable of controlling the fluid 14 and aspirates the fluid into conduit 20. Referring to FIG. 6b, as the leading surface 21 of the fluid 14 passes sensor 32 and then 30, the microprocessor 40 determines the flow rate of the fluid 14. Referring to FIG. 6C, when the correct amount of fluid 14 is aspirated, the conduit 20 is removed. Referring to FIG. 6d, the pump 18 then controls the fluid slug 15 within conduit 20 to above the sensors 32 and 30 and conduit 20 is moved to enable fluid slug 15 into container 13. Container 13 may be empty or partially full of other reagent fluids. Referring to FIG. 6e, the open end 23 of conduit 20 may be positioned above container 13 or within container 13 and the pump 18 control the fluid slug 15 and dispense it into container 13. As the fluid slug passes by sensors 32 and 30, the flow rate is again determined by the microprocessor 40 and when combined with the step count of the stepper motor and the time of dispense, the dispense volume is validated.

1. A system for dispensing small liquid volume which comprises:
a series of one or a plurality sensors capable of detecting the presence of fluid in a conduit wherein the sensors are connected to a microprocessor,
said microprocessor being programmed to record the time a fluid leading edge or meniscus within said conduit passes each of said sensors,
said microprocessor controlling a pump to cause fluid flow within said conduit for a specified period of time.

2. The system of claim 1 wherein said microprocessor is programmed to calculate the time the fluid leading edge of a flowing fluid within said conduit takes to travel from a first of said sensors to a second of said sensors.

3. The system of claim 1 wherein said microprocessor is programmed to calculate the time the fluid leading edge of a flowing fluid within said conduit takes to travel from a second of said sensors to a third of said sensors.

4. The system of claim 1 wherein the microprocessor is programmed to calculate the time the leading edge of a flowing fluid within said conduit takes to travel from a first of said sensors to a third of said sensors.

5. The system of claim 1 wherein the microprocessor, when the volume of the conduit is known between a first of said sensors and a second of said sensors, is programmed to calculate the flow rate of the fluid in the conduit.

6. The system of claim 1 wherein the microprocessor, when the volume of the conduit is known between a second of said sensors and a third of said sensors, is programmed to calculate the flow rate of the fluid in the conduit.

7. The system of claim 1 wherein the microprocessor can control the pump to make the fluid leading edge or meniscus within said conduit stop at any of a first of said sensors, a second of said sensors, or a third of said sensors.

8. The system of claim 1 wherein the microprocessor can control the pump to make the fluid leading edge or meniscus within said conduit stop at a first of said sensors and then accelerate the fluid in the conduit to a constant rate prior to a second of said sensors,
said microprocessor being capable of recording the time the leading edge or meniscus within said conduit passes a second of said sensors and a third of said sensors and to calculate the interval time and subsequently, the flow rate when the volume is known between the second of said sensors and the third of said sensors.

9. The system of claim 1 wherein the microprocessor can control the pump to make the fluid leading edge or meniscus within said conduit be positioned some distance between a valve and a first of said sensors, accelerate the leading edge or meniscus through the first of said sensors and the second of said sensors, calculate the flow rate within said conduit, start the timing of a dispense from said conduit when passing the third of said sensors, and to stop the dispense after a desired period of time when a desired discrete volume has been dispensed.

10. The system of claim 1 wherein the microprocessor can control the pump such that when a bubble passes the first of said sensors, the second of said sensors, or the third of said sensors, it can record the time the bubble takes to pass any one of said sensors and so that the pump pumps additional liquid to compensate for the lost volume of the bubble.

11. The system of claim 1 wherein the sensors are mounted remotely in a nozzle and connected via cable to a board of the microprocessor.

12. The system of claim 1 wherein the sensors are mounted remotely in a manifold and connected via cable to a board of the microprocessor.

13. The system in claim 1 wherein the sensitivity of the sensors are automatically calibrated with and without fluid in the conduit to maximize electronic signal output.
